(19) United States
(12) Patent Application Publication
(10) Pub. No.: US 2020/0265112 A1
(43) Pub. Date: Aug. 20, 2020

(54) DYNAMICALLY ADJUSTABLE CONTENT BASED ON CONTEXT

(71) Applicant: Microsoft Technology Licensing, LLC, Redmond, WA (US)

(72) Inventors: Seth Fox, Redmond, WA (US); Erez Kikin Gil, Bellevue, WA (US); Daniel P. Costenaro, Redmond, WA (US); Aleta E.C. Bashaw, Duvall, WA (US); Christopher Andrews Jung, Mercer Island, WA (US); Keri D. Talbot, Sammamish, WA (US)

(21) Appl. No.: 16/278,595

(22) Filed: Feb. 18, 2019

(51) Int. Cl. G06F 17/24; H04L 29/08; H04N 1/44; G06F 21/62

(52) U.S. Cl. CPC G06F 17/24; H04L 67/06; G06F 2221/2141; G06F 21/62; H04N 1/444

(57) ABSTRACT

A computing device receives a request to share a document to a plurality of recipients. The computing device determines a type of audience for each recipient and modifies the document based the type of audience for each recipient of the plurality of recipients. The computing device provides the modified document to the plurality of recipients.

### BACKGROUND

The subject matter disclosed herein generally relates to a special-purpose machine that dynamically adjust content of a shared document, including computerized variants of such special-purpose machines and improvements to such variants. Specifically, the present disclosure addresses systems and methods for dynamically adjusting content of a document based on a context of a recipient of the document.

An author of a document wishing to share the document to a group of recipients may have to manually adjust the content of the document to be relevant to specific audiences in the group of recipients. For example, the author may delete sensitive information from the document for some recipients who are not privy to the sensitive information. In another example, the author may add or modify other content that is relevant to other recipients. As such, the author may have to generate and send multiple documents to the group of recipients (e.g., email summary to a boss, a slide deck for a partner team, and a detailed document for peer engineers). Furthermore, once the author has received the feedback from the different recipient, the author has to manually recombine the feedback from different versions into a single document.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a diagrammatic representation of a networked environment in which the present disclosure may be deployed, in accordance with some example embodiments.

FIG. 2 is a block diagram illustrating an example of an operation of the dynamic content application in accordance with one example embodiment.

FIG. 3 is a block diagram illustrating a dynamic content client application in accordance with one example embodiment.

FIG. 4 is a block diagram illustrating a dynamic content server application in accordance with one example embodiment.

FIG. 5 is a flow diagram illustrating a method for publishing a modified document to a plurality of recipients in accordance with one example embodiment.

FIG. 6 is a flow diagram illustrating a method for displaying a modified document with content tailored to a recipient in accordance with one example embodiment.

FIG. 7 is a flow diagram illustrating a method for publishing a version of a document to a corresponding recipient in accordance with one example embodiment.

FIG. 8 is a flow diagram illustrating a method for publishing a document with adjusted content to the recipient in accordance with one example embodiment.

FIG. 9 is a flow diagram illustrating a method for unlocking and displaying a previously blocked portion of a modified document in accordance with one example embodiment.

FIG. 10 is a flow diagram illustrating a method for publishing a modified document to a plurality of recipients in accordance with one example embodiment.

FIG. 11 is a flow diagram illustrating a method for displaying portions of a modified document based on parsed metadata in accordance with one example embodiment.

FIG. 12 illustrates a screenshot in accordance with one example embodiment.

FIG. 13 illustrates a screenshot in accordance with one example embodiment.

FIG. 14 illustrates a screenshot in accordance with one example embodiment.

FIG. 15 illustrates branches of a shared document in accordance with one example embodiment.

FIG. 16 is a diagrammatic representation of a machine in the form of a computer system within which a set of instructions may be executed for causing the machine to perform any one or more of the methodologies discussed herein, according to an example embodiment.

### DETAILED DESCRIPTION

“Processor” refers to any circuit or virtual circuit (a physical circuit emulated by logic executing on an actual processor) that manipulates data values according to control signals (e.g., “commands”, “op codes”, “machine code”, etc.) and which produces corresponding output signals that are applied to operate a machine. A processor may, for example, be a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific integrated Circuit (ASIC), a Radio-Frequency Integrated Circuit (RFIC) or any combination thereof. A processor may further be a multi-core processor having two or more independent processors (sometimes referred to as “cores”) that may execute instructions contemporaneously.

“Signal Medium” refers to any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

“Machine-Storage Medium” refers to a single or multiple storage devices and/or media (e.g., a centralized or distributed database, and/or associated caches and servers) that store executable instructions, routines and/or data. The term shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Computer-Readable Medium” refers to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Component” refers to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application specific integrated circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component”(or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some example embodiments, the processors or processor-implemented components may be located in a single geographic location (e.g., within a home environment, an office environment, or a server farm). In other example embodiments, the processors or processor-implemented components may be distributed across a number of geographic locations.

“Carrier Signal” refers to any intangible medium that is capable of storing, encoding, or carrying instructions for execution by the machine, and includes digital or analog communications signals or other intangible media to facilitate communication of such instructions. Instructions may be transmitted or received over a network using a transmission medium via a network interface device.

“Communication Network” refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

The description that follows describes systems, methods, techniques, instruction sequences, and computing machine program products that illustrate example embodiments of the present subject matter. In the following description, for purposes of explanation, numerous specific details are set forth in order to provide an understanding of various embodiments of the present subject matter. It will be evident, however, to those skilled in the art, that embodiments of the present subject matter may be practiced without some or other of these specific details. Examples merely typify possible variations. Unless explicitly stated otherwise, structures (e.g., structural components, such as modules) are optional and may be combined or subdivided, and operations (e.g., in a procedure, algorithm, or other function) may vary in sequence or be combined or subdivided.

The present application describes a system that creates, tailors, and share a document with different content for different audiences. For example, an author can publish or share the same document to communicate differently to different audiences (e.g., accounting personal, an engineer of an organization, executive of an organization) without having to draft a separate version for each audience. As such, the system enables the author to automatically generate multiple types of outputs from a single document. For example, a single document may include different content (e.g., multiple branches of the same original content) while keep the single document in sync.

In another example, the system enables the author to focus their content to individual audiences by adding annotations by who will be consuming the content (e.g., the author selects a paragraph to associate it with the accounting department), thereby creating a more targeted view of the document,

In another example, the system enables the author to share confidential content by indicating specific content private or sensitive and allowing select recipients to sign in and request to view the confidential content. This confidential content can be blurred, blackened, summarized, or have other visual ways of denoting restricted access in the shared or published document, in another example, the recipient inherits the permission level from the organization that the author is part of.

In another example, the system enables a reader/recipient to quickly filter the shared document to people, things, and events pertinent to the recipient in the shared document. Common highlights and key points can help the reader to quickly identify important parts of the document. As the recipient filters the shared document, key points and highlights adapt accordingly to relate to the entities the recipient is interested in.

The present application describes a system and method for publishing a dynamically adjustable content document based on a context of the recipient. In one example embodiment, a computing device is configured to receive a request to share a document to a plurality of recipients, determine a type of audience for each recipient, modify the document based the type of audience for each recipient of the plurality of recipients, and provide the modified document to the plurality of recipients.

As a result, one or more of the methodologies described herein facilitate solving the technical problem of drafting (using a document application operating in a computing device) multiple versions of a single document for different audiences. As such, one or more of the methodologies described herein may obviate a need for certain efforts or computing resources. Examples of such computing resources include processor cycles, network traffic, memory usage, data storage capacity, power consumption, network bandwidth, and cooling capacity.

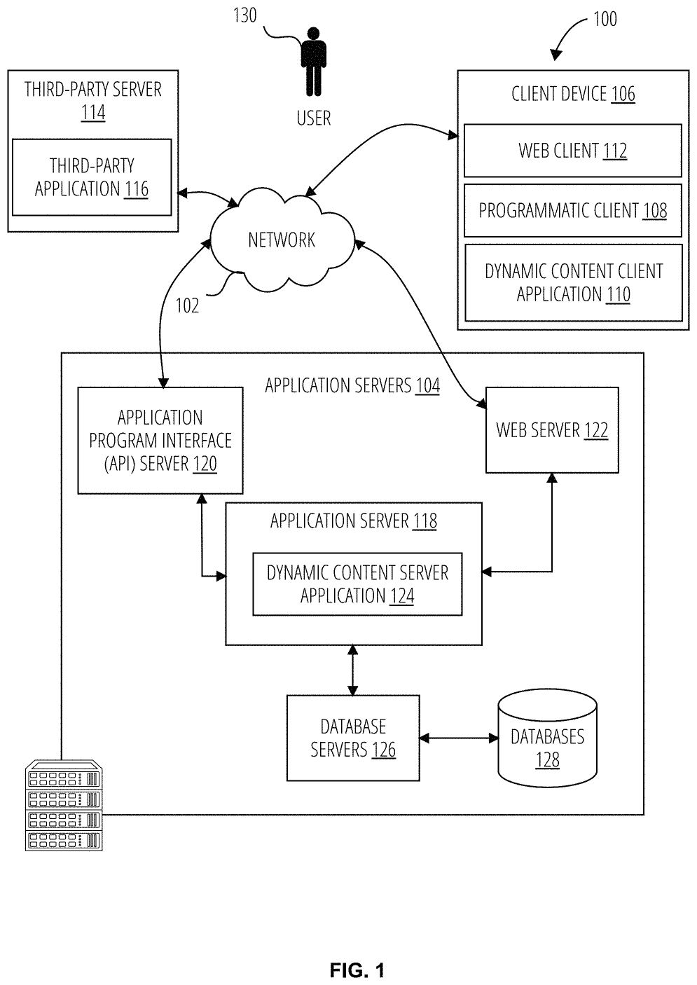

FIG. 1 is a diagrammatic representation of a network environment in which some example embodiments of the present disclosure may be implemented or deployed. One or more application servers 104 provide server-side functionality via a network 102 to a networked user device, in the form of a client device 106. The client device 106 includes a web client 112 (e.g., a browser), a programmatic client 108 (e.g., Microsoft Word (™) “app”) that is hosted and executed on the client device 106, and a dynamic content client application 110 that generates a graphical user interface to visualize changes to shared document. The dynamic content client application 110 may operate with the web client 112 and/or the programmatic client 108. In another example embodiment, the dynamic content client application 110 is part of the programmatic client 108 or web client 112.

An Application Program Interface (API) server 120 and a web server 122 provide respective programmatic and web interfaces to application servers 104. A specific application server 118 hosts a dynamic content server application 124, which includes components, modules and/or applications. The dynamic content server application 124 receives a document, modifies the document based on the recipients, and publishes the modified document. In another example embodiment, the dynamic content server application 124 receives a request to publish a shared document from the client device 106. The dynamic content server application 124 identifies the recipients and forwards the shared document to the recipients. In yet another example embodiment, the dynamic content server application 124 receives multiple versions of the shared document. Each version is associated with a corresponding audience or group of recipients. The dynamic content server application 124 sends each version to its corresponding audience or group of recipients. In yet another example embodiment, the dynamic content server application 124 receives a single document with metadata identifying portions of the document corresponding to different audience or group of recipients from the dynamic content client application 110. The dynamic content server application 124 creates a version of the single document for each audience based on the metadata and forwards that version to the corresponding audience. In another example, the dynamic content server application 124 receives the single document with metadata from dynamic content client application 110 and forwards it to the group of recipients.

In one example embodiment, the dynamic content client application 110 communicates with the dynamic content server application 124 supported by the web server 122 to access the graphical user interface. In one example, the web client 112 communicate with the dynamic content server application 124 via the programmatic interface provided by the Application Program Interface (API) server 120. In another example, the dynamic content client application 110 communicates with the dynamic content server application 124.

The third-party application 116 may, for example, be another cloud storage system or another media provider. The application server 118 is shown to be communicatively coupled to database servers 126 that facilitates access to an information storage repository or databases 128. In an example embodiment, the databases 128 includes storage devices that store information to be published and/or processed by the dynamic content server application 124.

Additionally, a third-party application 116 executing on a third-party server 114, is shown as having programmatic access to the application server 118 via the programmatic interface provided by the Application Program Interface (API) server 120. For example, the third-party application 116, using information retrieved from the application server 118, may supports one or more features or functions on a website hosted by the third party.

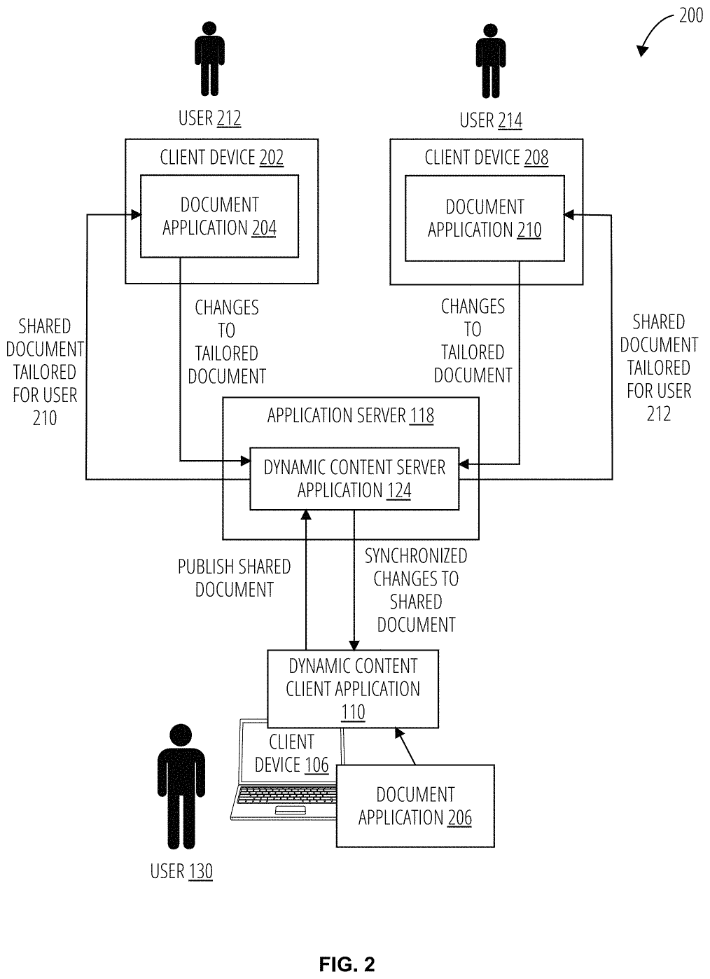

FIG. 2 is a block diagram illustrating an example of an operation of the dynamic content server application in accordance with one example embodiment. The user 130 operates a document application 206 (e.g., Microsoft Word™) at a client device 106 to generate a document and share or publish the document to selected recipients. For example, the user 130 selects the accounting group, the engineering group, and the human resource group as recipient of the document. The document application 206 provides the list/group of recipients and the document to the dynamic content client application 110. The dynamic content client application 110 publishes the document to the dynamic content server application 124. The dynamic content server application 124 tailors the document for a user based on a type of output (e.g., an audience type) corresponding to each recipient. For example, one type of output may be based on a job title, a job status, a department of an organization, or any arbitrary way to categorize the recipients. For example, the dynamic content server application 124 removes a financial report or financial content from the document for recipients with “non-executive” job level. Conversely, the dynamic content server application 124 adds or keeps financial content in the document for recipients with “executive” job level. The dynamic content server application 124 may replace sections of the document for recipient who are outside the organization (e.g., recipients that do not work at the organization)

In one example embodiment, the dynamic content server application 124 tailors the shared document for user 212 based on a job department associated with user 212. The dynamic content server application 124 publishes the tailored document to the document application 204 of the client device 202 associated with the user 212. Similarly, the dynamic content server application 124 tailors the shared document for user 214 based on a job department associated with user 214. The dynamic content server application 124 publishes the tailored document to the document application 210 of the client device 208 associated with the user 212.

In another example embodiment, the user 212 reads the tailored document and performs some changes edit the document) with the document application 204. The document application 204 sends the changes to the dynamic content server application 124. Similarly, the user 212 reads the tailored document and performs some changes (e.g., edit the document) with the document application 210. The document application 210 sends the changes to the dynamic content server application 124. The dynamic content server application 124 receives the changes from user 212 and user 214, and synchronizes the changes to the shared document. The dynamic content server application 124 sends the shared document to the dynamic content client application 110.

In another example embodiment, the dynamic content client application 110 tailors the shared document for user 212 based on a job department associated with user 212. The dynamic content client application 110 publishes the tailored document to dynamic content server application 124. The dynamic content server application 124 forwards the tailored document to the document application 204 of the client device 202 associated with the user 212. Similarly, the dynamic content client application 110 tailors the shared document for user 214 based on a job department associated with user 214. The dynamic content client application 110 publishes the tailored document to dynamic content server application 124. The dynamic content server application 124 forwards the tailored document to the document application 210 of the client device 208 associated with the user 214.

In another example embodiment, the dynamic content client application 110 sends the shared document to the dynamic content server application 124. The shared document may include metadata that indicate portions of the content that are pertinent for each type of audience (e.g., financials data pertinent to accounting department, executive summary pertinent to executive level). The dynamic content server application 124 forwards the shared document to the recipients (e.g., user 212, user 214). The user 212 uses the document application 204 to view the shared document. The document application 204 parses the metadata of the shared document and only displays portions of document that are pertinent or relevant to the user 212. In another example, the document application 204 omits or blocks a portion of the shared document based on a viewing privilege of the user 212 and a confidentiality level of the portion of the shared document (e.g., paragraph one is top secret, paragraph two is sensitive, paragraph three is public information). The user 212 may submit a permission request to access the blocked out portion of the shared document. The user 214 uses the document application 210 to view the shared document. The document application 210 parses the metadata of the shared document and only displays portions of document that are pertinent or relevant to the user 214.

In another example embodiment, the document application 204 uses the parsed metadata to identify portions of the document that are relevant or pertinent to the user 212. For example, the document application 204 displays highlights or a summary of the shared document for the user 212 based on the audience type of the user 212 (e.g., executive level).

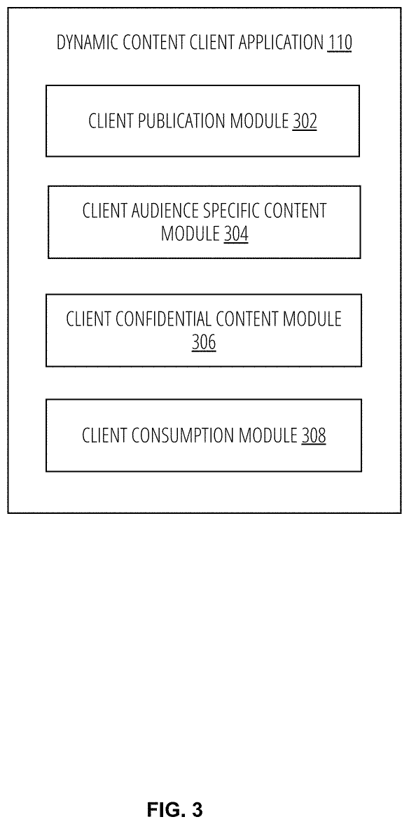

FIG. 3 is a block diagram illustrating a dynamic content client application 110 in accordance with one example embodiment. The dynamic content client application 110 comprises a client publication module 302, a client audience specific content module 304, and a client confidential content module 306. The client publication module 302 publishes or communicates a document (also referred to as shared document) to a group of recipients. In one example, the client publication module 302 shares a single document to the dynamic content server application 124. In another example, the client publication module 302 shares multiple versions of the single document to the dynamic content server application 124.

The client audience specific content module 304 identifies the type of audience based on a profile of the recipients. For example, one type of audience may be based on job status (e.g., employed, on leave) or job level (e.g., associate, manager, supervisor, director) or any other types. In one example, the user 130 identifies the audience type for one or more portions of the document. For example, the user 130 identifies a paragraph containing financial results with an executive level audience. In another example, portions of the document that were not selected or identified by the user 130 retains the same content for every recipient. For example, if client audience specific content module 304 detects that the user 130 did not associate the conclusion paragraph of the document for a specific audience, the conclusion paragraph remains the same for every recipient.

In one example embodiment, the client audience specific content module 304 modifies the document to generate a single document with metadata indicating portions of the document with their corresponding audiences. In another example embodiment, the client audience specific content module 304 generates multiple versions of the document based on the type of audience of the recipients.

The client confidential content module 306 determines whether a portion of the document contains confidential or sensitive information. In one example, the client confidential content module 306 determines that the user 130 has identified a particular paragraph as confidential and has indicated the audience type (e.g., executives only) for the confidential content.

The client consumption module 308 generates a highlight or summary of the changes to the shared document. In another example, the client audience specific content module 304 determines changes that are relevant to the user based on a context of the user 212 (e.g., user credentials, user profile, user interest, related documents) or privacy settings of the user 212). In another example, the client audience specific content module 304 displays or highlights portions of the document that may be relevant to the user 212 based on the context.

In another example, the client consumption module 308 receives a selection of a portion of the shared document and generates a summary of relevant information pertaining to the selected portion of the shared document. Only the summary of relevant information is displayed with respect to the portion of the shared document (to enables the user 212 to filter any non-relevant content or noise in the shared document).

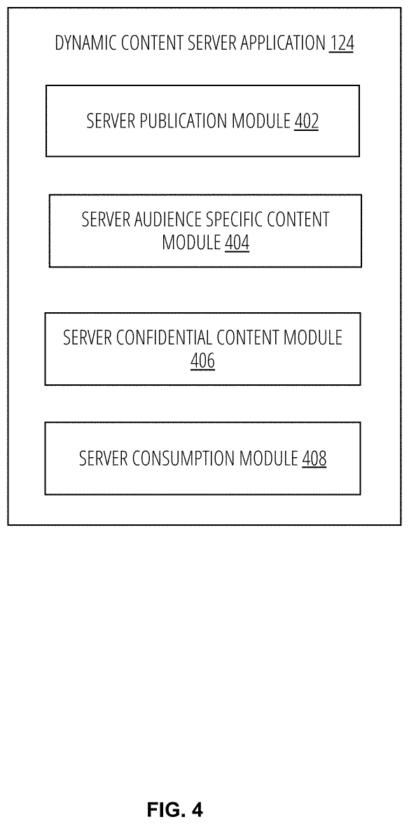

FIG. 4 illustrates a dynamic content server application in accordance with one embodiment. The dynamic content server application 124 comprises a server publication module 402, a server audience specific content module 404, and a server confidential content module 406. The server publication module 402 operates similarly to the client publication module 302 of the dynamic content client application 110. In one example, the server publication module 402 receives a single document from the client publication module 302. In another example, the server publication module 402 receives multiple versions of a document from the client publication module 302.

The server audience specific content module 404 operates similarly to the client audience specific content module 304 of the dynamic content client application 110. In one example embodiment, the server audience specific content module 404 modifies the single document received from dynamic content client application 110 and generates a single document with metadata indicating portions of the document with their corresponding audiences. In another example embodiment, the server audience specific content module 404 modifies the single document received from dynamic content client application 110 and generates multiple versions of the document based on the type of audience of the recipients.

The server confidential content module 406 operates similarly to the client confidential content module 306 of the dynamic content client application 110. The server consumption module 408 operates similarly to the server confidential content module 406 of the dynamic content client application 110.

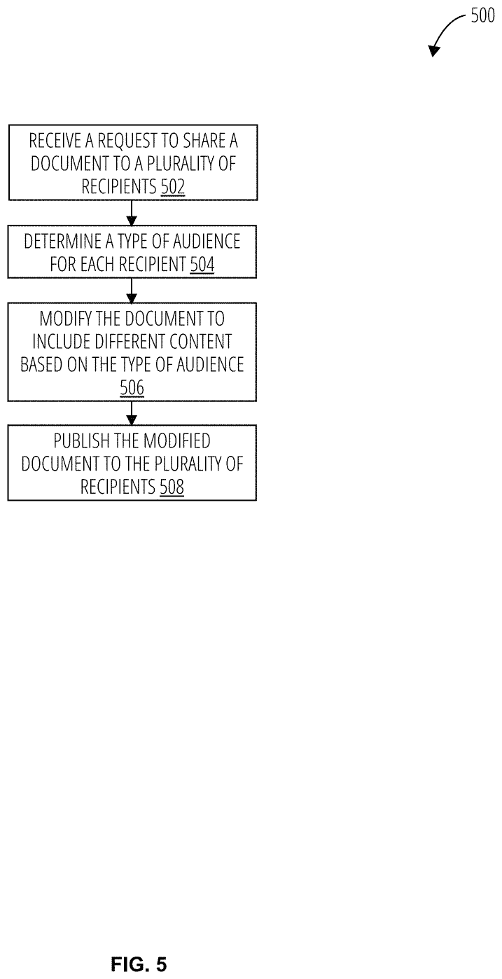

FIG. 5 is a flow diagram illustrating a method 500 for publishing a modified document to recipients in accordance with one example embodiment. Operations in the method 500 may be performed by the dynamic content client application 110, using components (e.g., modules, engines) described above with respect to FIG. 3. Accordingly, the method 500 is described by way of example with reference to the dynamic content client application 110. However, it shall be appreciated that at least some of the operations of the method 500 may be deployed on various other hardware configurations or be performed by similar components residing elsewhere. For example, some of the operations may be performed at the dynamic content server application 124.

In block 502, the dynamic content client application 110 receives a request to share a document to a plurality of recipients. At block 504, the dynamic content client application 110 determines a type of audience for each recipient. At block 506, the dynamic content client application 110 modifies the document to include different content based on the type of audience. At block 508, the dynamic content client application 110 publishes the modified document to the recipients.

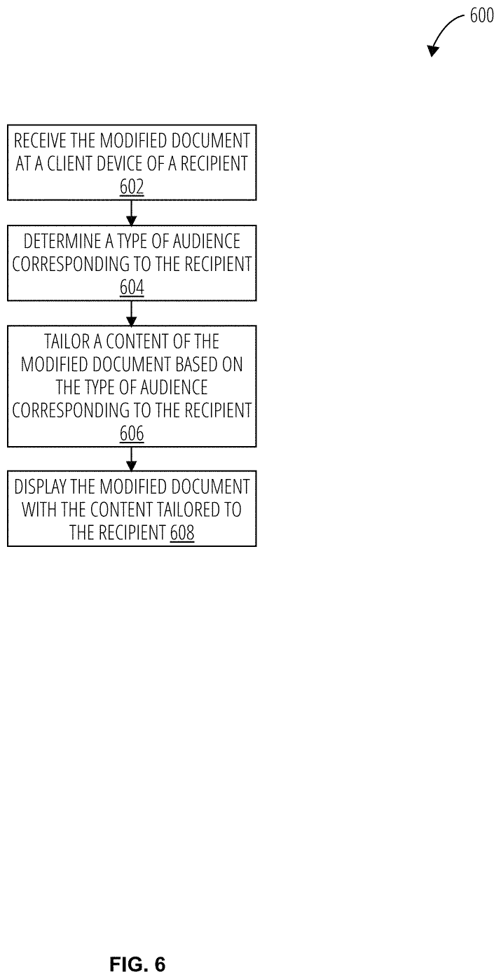

FIG. 6 is a flow diagram illustrating a method 600 displaying the modified document with the content tailored to the recipient in accordance with one example embodiment. Operations in the method 600 may be performed by the document application 204, the dynamic content client application 110, or the dynamic content server application 124, using components (e.g., modules, engines) described above with respect to FIG. 3 and FIG. 4. However, it shall be appreciated that at least some of the operations of the method 600 may be deployed on various other hardware configurations or be performed by similar components residing elsewhere. For example, some of the operations may be performed at the dynamic content server application 124, and at the dynamic content client application 110.

In block 602, the document application 204 receives the modified document. At block 604, the document application 204 determines a type of audience corresponding to the recipient (e.g., user 212). At block 606, the document application 204 tailors content in the modified document based on a type of audience corresponding to the user 212. At block 608, the document application 204 displays the modified document with the content being tailored to the recipient.

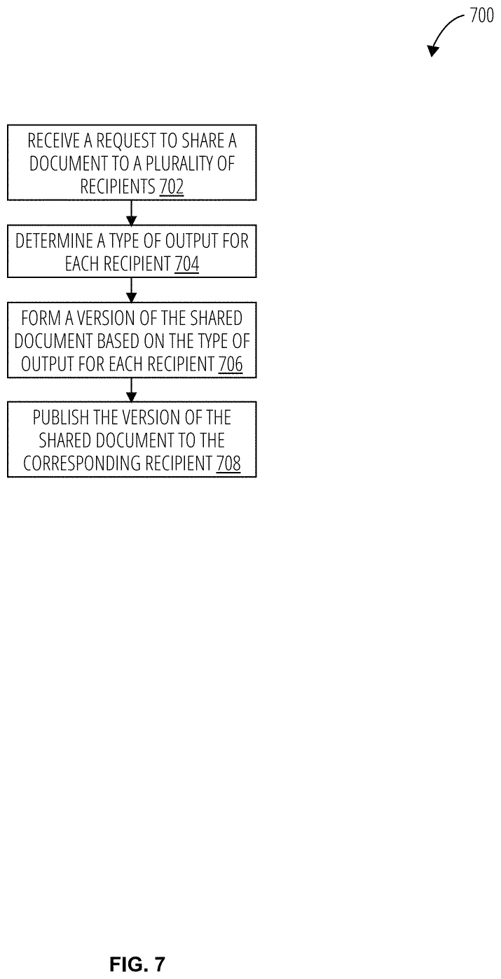

FIG. 7 is a flow diagram illustrating a method 700 for publishing a version of a shared document to a corresponding recipient in accordance with one example embodiment. Operations in the method 700 may be performed by the dynamic content client application 110, using components (e.g., modules, engines) described above with respect to FIG. 3. Accordingly, the method 700 is described by way of example with reference to the dynamic content client application 110. However, it shall be appreciated that at least some of the operations of the method 700 may be deployed on various other hardware configurations or be performed by similar components residing elsewhere. For example, some of the operations may be performed at the dynamic content server application 124.

In block 702, the dynamic content client application 110 receives a request to share a document to a plurality of recipients. At block 704, the dynamic content client application 110 determines a type of output for each recipient (e.g., executives, accounting personnel). At block 706, the dynamic content client application 110 forms or generates a version of the shared document based on the type of output for each recipient (e.g., add a short summary and remove detailed financial data for executives, keep detailed financial data for accounting personnel). At block 708, the dynamic content client application 110 publishes the version of the shared document to the corresponding recipient.

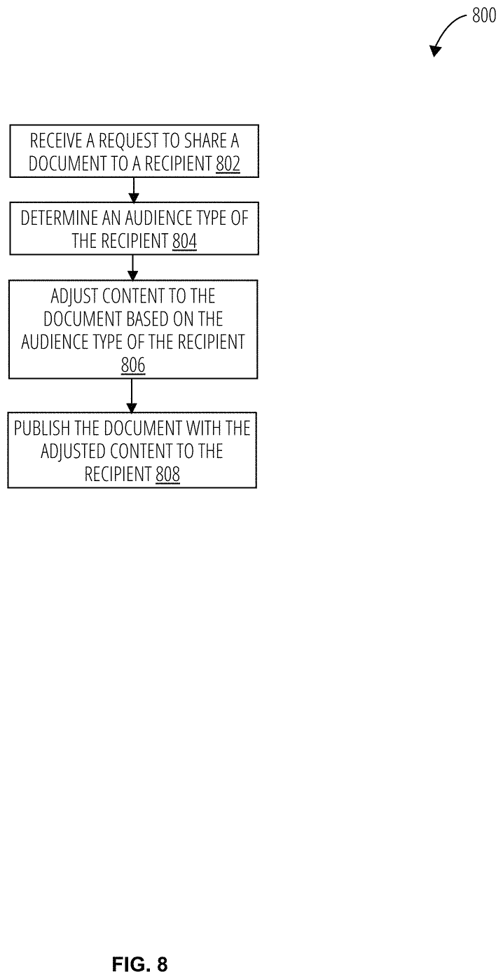

FIG. 8 is a flow diagram illustrating a method 800 for publishing a document with the adjusted content to a recipient in accordance with one example embodiment. Operations in the method 800 may be performed by the dynamic content client application 110, using components (e.g., modules, engines) described above with respect to FIG. 3. Accordingly, the method 800 is described by way of example with reference to the dynamic content client application 110. However, it shall be appreciated that at least some of the operations of the method 800 may be deployed on various other hardware configurations or be performed by similar components residing elsewhere. For example, some of the operations may be performed at the dynamic content server application 124.

In block 802, the dynamic content client application 110 receives a request to share a document to a recipient. At block 804, the dynamic content client application 110 determines an audience type of the recipient. At block 806, the dynamic content client application 110 adjusts the content of the document based on the audience type of the recipient. At block 808, the dynamic content client application 110 publishes the document with the adjusted content to the recipient.

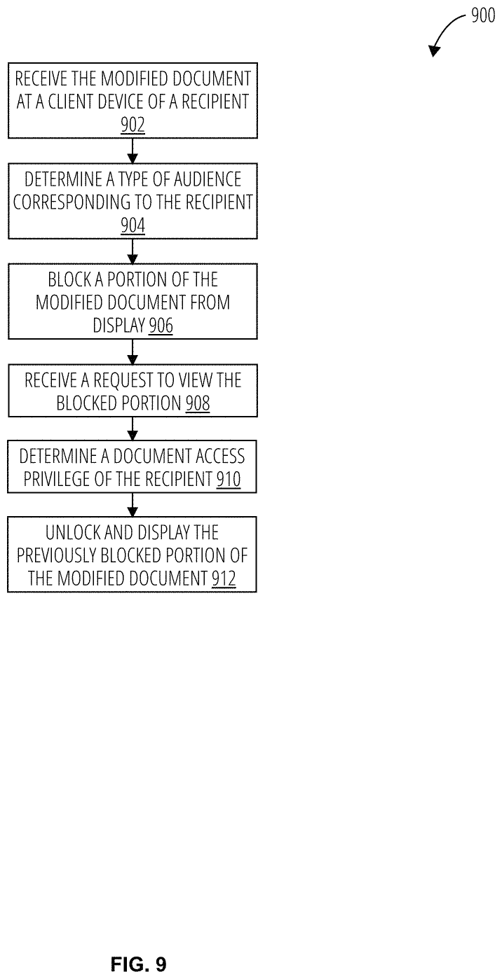

FIG. 9 is a flow diagram illustrating a method 900 for unlocking and displaying a blocked portion of a document in accordance with one example embodiment. Operations in the method 900 may be performed by the document application 204, the dynamic content client application 110, or the dynamic content server application 124, using components (e.g., modules, engines) described above with respect to FIG. 3 and FIG. 4. Accordingly, the method 900 is described by way of example with reference to the dynamic content client application 110. However, it shall he appreciated that at least some of the operations of the method 900 may be deployed on various other hardware configurations or be performed by similar components residing elsewhere. For example, some of the operations may be performed at the dynamic content server application 124.

In block 902, the document application 204 receives the modified document at the client device 202 of a recipient (e.g., user 212). The document application 204 (or the dynamic content server application 124 or dynamic content client application 110) determines a type of audience corresponding to the user 212. The document application 204 (or the dynamic content client application 110 or dynamic content server application 124) blocks a portion of the modified document from display. At block 908, the dynamic content client application 110 or dynamic content server application 124) receives a request from the user 212 to view the blocked portion. At block 910, the dynamic content client application 110 or the dynamic content server application 124 (or the document application 204) determines a document access privilege of the recipient. At block 912, the document application 204 or dynamic content client application 110 or dynamic content server application 124 unlocks the blocked portion and causes the document application 204 to display the previously blocked portion of the modified document.

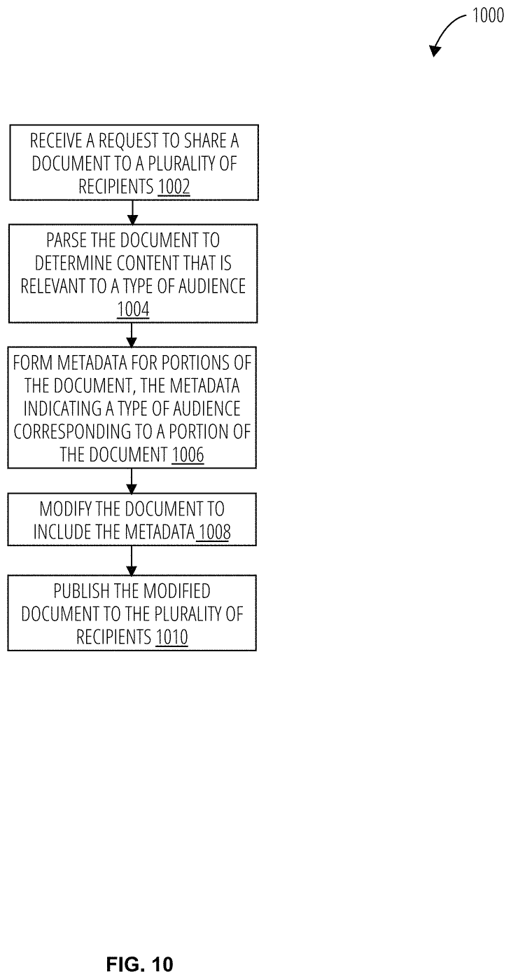

FIG. 10 is a flow diagram illustrating a method 1000 for publishing the modified document to recipients in accordance with one example embodiment. Operations in the method 1000 may be performed by the dynamic content client application 110, using components (e.g., modules, engines) described above with respect to FIG. 3. Accordingly, the method 1000 is described by way of example with reference to the dynamic content client application 110. However, it shall be appreciated that at least some of the operations of the method 1000 may be deployed on various other hardware configurations or be performed by similar components residing elsewhere. For example, some of the operations may be performed at the dynamic content server application 124.

In block 1002, the dynamic content client application 110 receives a request to share a document to a plurality of recipients. At block 1004, the dynamic content client application 110 parses the document to determine content that is relevant or pertinent to a type of audience (e.g., for example, by identifying key words in the document or using metadata; some key words may be associated with specific audience). At block 1006, the dynamic content client application 110 forms metadata for portions of the document. The metadata indicates a type of audience corresponding to a portion of the document. At block 1008, the dynamic content client application 110 modifies the document to include the metadata. At block 1010, the dynamic content client application 110 publishes the modified document to the plurality of recipients.

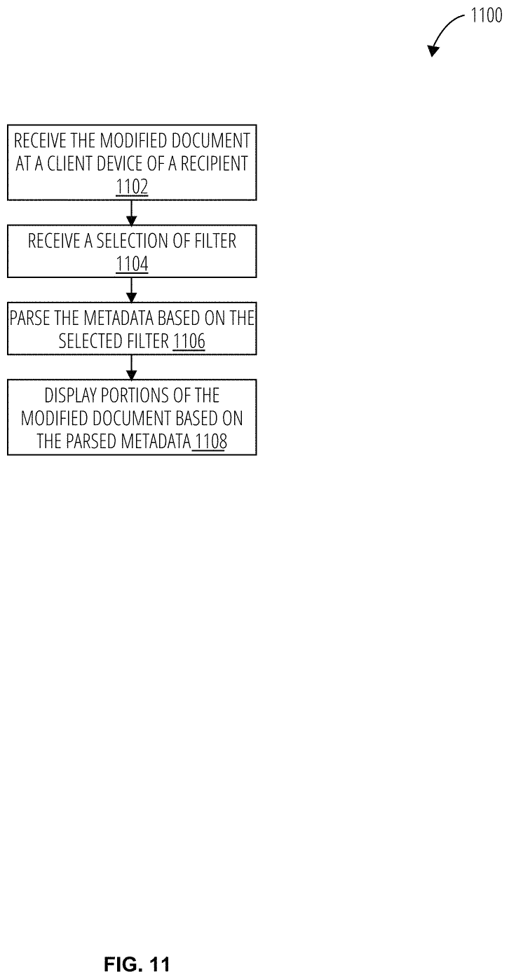

FIG. 11 is a flow diagram illustrating a method 1100 for causing a display of portions of the modified document based on the parsed metadata in accordance with one example embodiment. Operations in the method 1100 may be performed by the document application 204, the dynamic content client application 110, or the dynamic content server application 124. using components (e.g., modules, engines) described above with respect to FIG. 3 and FIG. 4. Accordingly, the method 1100 is described by way of example with reference to the dynamic content client application 110. However, it shall be appreciated that at least some of the operations of the method 1100 may be deployed on various other hardware configurations or be performed by similar components residing elsewhere. For example, some of the operations may be performed at the dynamic content server application 124.

In block 1102, the document application 204 associated with user 212 receives the modified document. At block 1104, the document application 204 receives a selection of filter from the user 212. For example, the user 212 selects a highlight filter that summarizes or only display information pertinent to the user 212 (based on an audience type of the user 212). At block 1106, the document application 204 parses the metadata in the modified document based on the selected filter. At block 1108, the document application 204 displays or highlights portions of the modified document based on the parsed metadata. In another example, the document application 204 blocks out portions of the modified documents outside the highlighted portions.

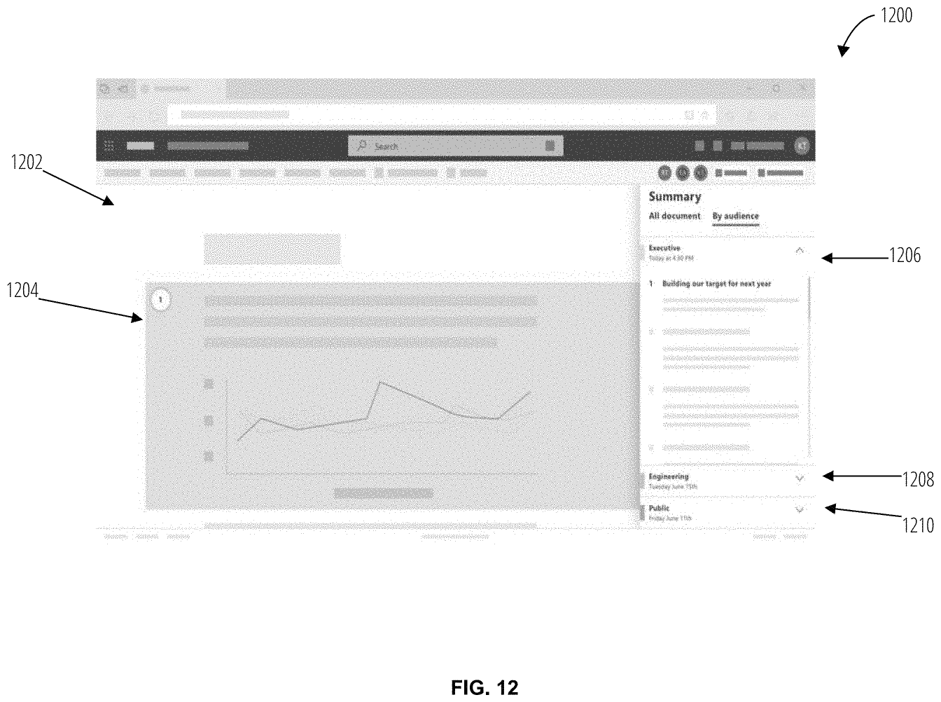

FIG. 12 illustrates a screenshot 1200 in accordance with one embodiment. The screenshot 1200 illustrates a shared document 1202. The shared document 1202 displays a portion of the content that is relevant to a recipient based on an audience type of the recipient. For example, the shared document 1202 displays different types of audience (e.g., executive audience 1206, engineering audience 1208, and public audience 1210). When the recipient selects the executive audience 1206, the corresponding relevant portion of the document is displayed or highlighted (e.g., portion pertinent to executives 1204).

In one example embodiment, the recipient may be able to see different portions of the shared document 1202 for each audience. In another example embodiment, the recipient may be able to only see the portions of the shared document 1202 that is pertinent to the audience assigned to the recipient.

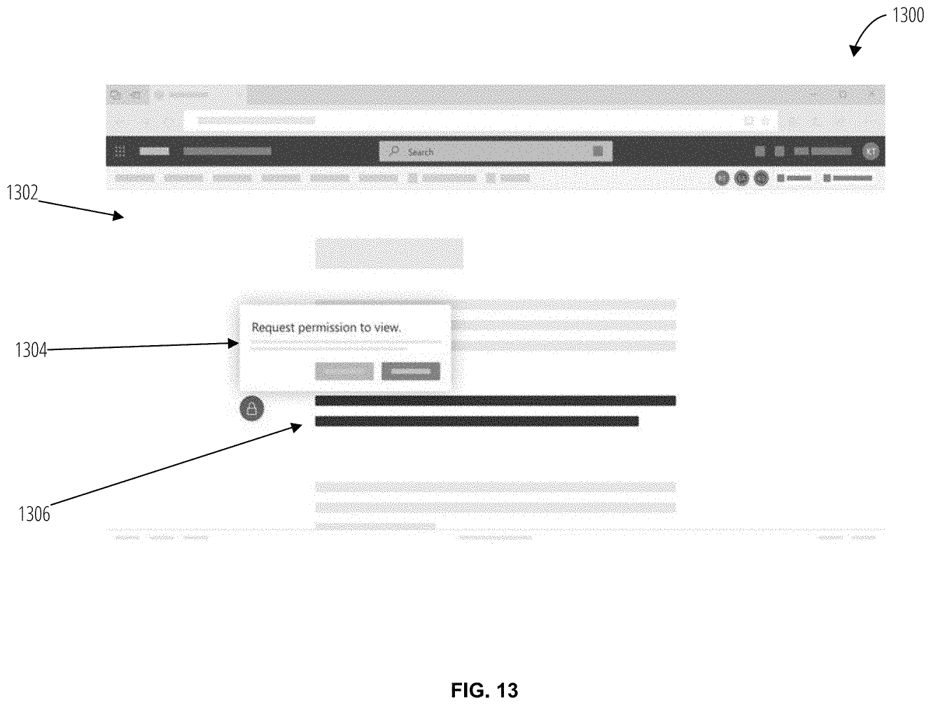

FIG. 13 illustrates a screenshot 1300 in accordance with one embodiment. The screenshot 1300 illustrates a shared document 1302 that includes a confidential portion 1306. The confidential portion 1306 may be blacked out or redacted to prevent the recipient from viewing the confidential portion 1306. However, the recipient may be able to submit a request for permission to view (e.g., permission to view request 1304) the confidential portion 1306.

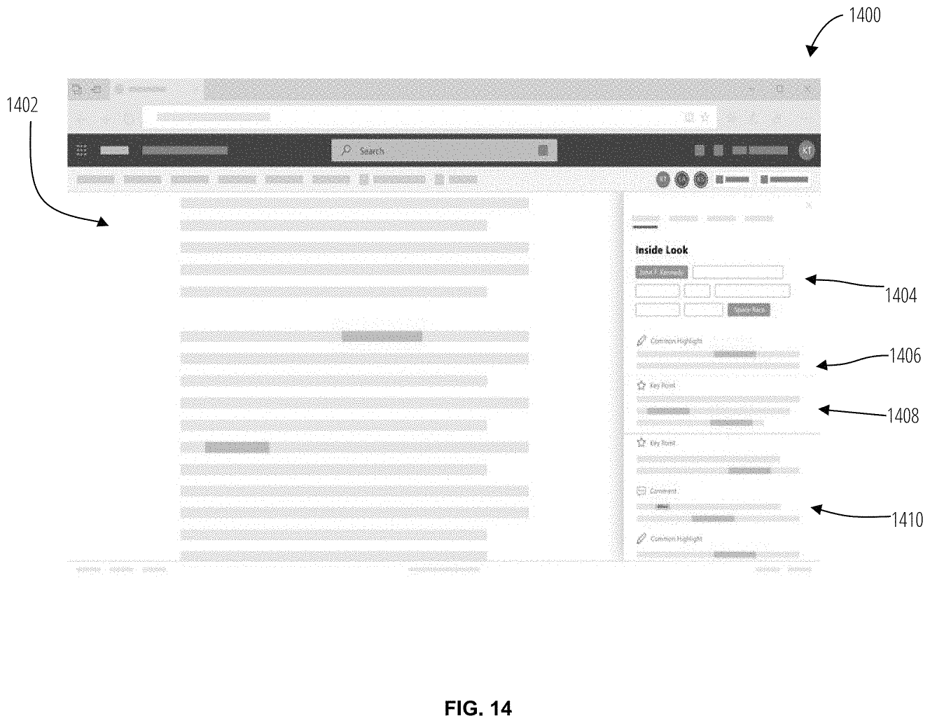

FIG. 14 illustrates a screenshot 1400 in accordance with one embodiment. The screenshot 1400 illustrates a shared document 1402 with filters 1404. For example, a recipient of the document may be able to identify pertinent information with ease by using the filters 1404. Examples of filters 1404 include common highlight 1406, key priority 1408, and comment 1410.

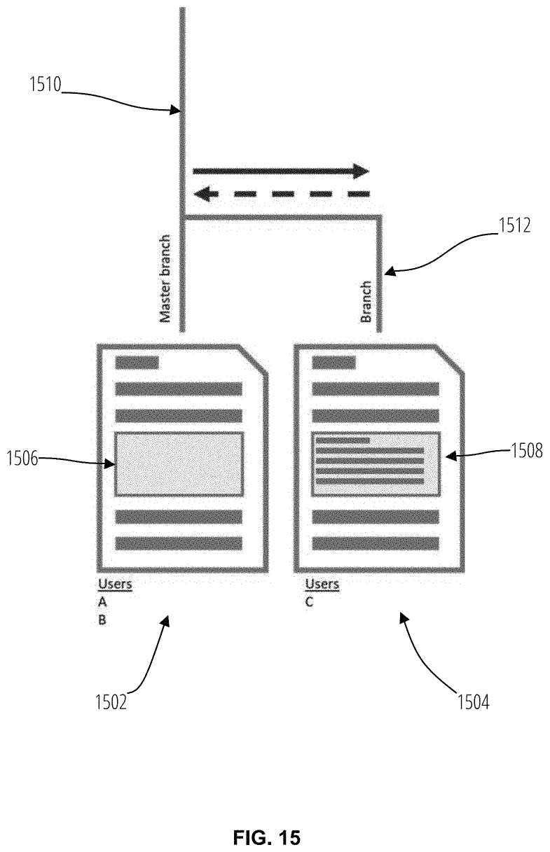

FIG. 15 illustrates branches of a shared document in accordance with one example embodiment. A master branch 1510 splits into another branch 1512. The master branch shared document 1502 of the master branch 1510 is shared with users A and B. The branch shared document 1504 of the branch 1512. is shared with user C. The master branch shared document 1502 includes redacted content 1506. The users A and B cannot view the content of the redacted content 1506 (because it has been omitted). The branch shared document 1504 includes non-redacted content 1508. The user C can view the content of the non-redacted content 1508.

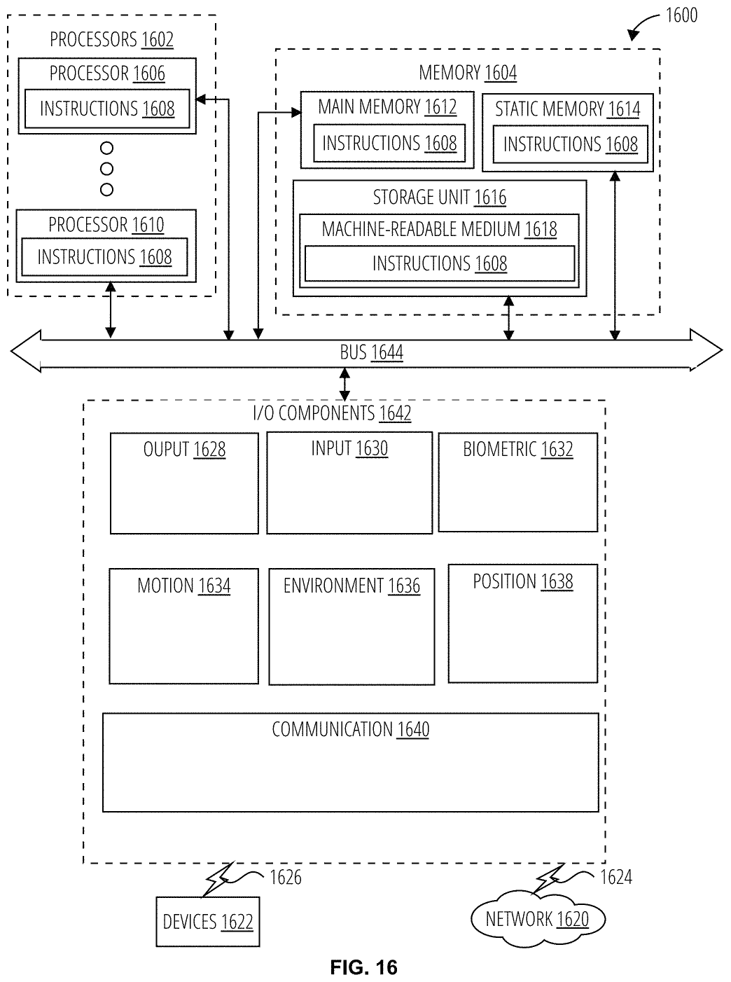

FIG. 16 is a diagrammatic representation of the machine 1600 within which instructions 1608 (e.g., software, a program, an application, an applet, an app, or other executable code) for causing the machine 1600 to perform any one or more of the methodologies discussed herein may be executed, For example, the instructions 1608 may cause the machine 1600 to execute any one or more of the methods described herein. The instructions 1608 transform the general, non-programmed machine 1600 into a particular machine 1600 programmed to carry out the described and illustrated functions in the manner described. The machine 1600 may operate as a standalone device or may be coupled (e.g., networked) to other machines. In a networked deployment, the machine 1600 may operate in the capacity of a server machine or a client machine in a server-client network environment, or as a peer machine in a peer-to-peer (or distributed) network environment. The machine 1600 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1608, sequentially or otherwise, that specify actions to be taken by the machine 1600. Further, while only a single machine 1600 is illustrated, the term “machine” shall also be taken to include a collection of machines that individually or jointly execute the instructions 1608 to perform any one or more of the methodologies discussed herein.

The machine 1600 may include processors 1602, memory 1604, and I/O components 1642, which may be configured to communicate with each other via a bus 1644. In an example embodiment, the processors 1602 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated. Circuit (RFIC), another processor, or any suitable combination thereof) may include, for example, a processor 1606 and a processor 1610 that execute the instructions 1608. The term “processor” is intended to include multi-core processors that may comprise two or more independent processors (sometimes referred to as “cores”) that may execute instructions contemporaneously. Although FIG. 16 shows multiple processors 1602, the machine 1600 may include a single processor with a single core, a single processor with multiple cores (e.g., a multi-core processor), multiple processors with a single core, multiple processors with multiples cores, or any combination thereof.

The memory 1604 includes a main memory 1612, a static memory 1614, and a storage unit 1616, both accessible to the processors 1602 via the bus 1644. The main memory 1604, the static memory 1614, and storage unit 1616 store the instructions 1608 embodying any one or more of the methodologies or functions described herein. The instructions 1608 may also reside, completely or partially, within the main memory 1612, within the static memory 1614, within machine-readable medium 1618 within the storage unit 1616, within at least one of the processors 1602 (e.g., within the processor's cache memory), or any suitable combination thereof, during execution thereof by the machine 1600.

The I/O components 1642 may include a wide variety of components to receive input, provide output, produce output, transmit information, exchange information, capture measurements, and so on. The specific I/O components 1642 that are included in a particular machine will depend on the type of machine. For example, portable machines such as mobile phones may include a touch input device or other such input mechanisms, while a headless server machine will likely not include such a touch input device. It will be appreciated that the I/O components 1642 may include many other components that are not shown in FIG. 16. In various example embodiments, the I/O components 1642 may include output components 1628 and input components 1630. The output components 1628 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1630 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 1642 may include biometric components 1632, motion components 1634, environmental components 1636, or position components 1638, among a wide array of other components. For example, the biometric components 1632 include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1634 include acceleration sensor components (e.g., accelerometer), gravitation sensor components, rotation sensor components (e.g., gyroscope), and so forth. The environmental components 1636 include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1638 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The components 1642 further include communication components 1640 operable to couple the machine 1600 to a network 1620 or devices 1622 via a coupling 1624 and a coupling 1626, respectively. For example, the communication components 1640 may include a network interface component or another suitable device to interface with the network 1620. In further examples, the communication components 1640 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1622 may be another machine or any of a wide variety of peripheral devices (e.g., a peripheral device coupled via a USB).

Moreover, the communication components 1640 may detect identifiers or include components operable to detect identifiers. For example, the communication components 1640 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1640, such as location via Internet Protocol (IP) geolocation, location via Wi-Fi® signal triangulation, location via detecting an NFC beacon signal that may indicate a particular location, and so forth.

The various memories (e.g., memory 1604, main memory 1612, static memory 1614, and/or memory of the processors 1602) and/or storage unit 1616 may store one or more sets of instructions and data structures (e.g., software) embodying or used by any one or more of the methodologies or functions described herein. These instructions (e.g., the instructions 1608), when executed by processors 1602, cause various operations to implement the disclosed embodiments.

The instructions 1608 may be transmitted or received over the network 1620, using a transmission medium, via a network interface device (e.g., a network interface component included in the communication components 1640) and using any one of a number of well-known transfer protocols (e.g., hypertext transfer protocol (HTTP)). Similarly, the instructions 1608 may be transmitted or received using a transmission medium via the coupling 1626 (e.g., a peer-to-peer coupling) to the devices 1622.

### EXAMPLES

Example 1 is a computer-implemented method comprising: receiving a request to share a document to a plurality of recipients; determining a type of audience for each recipient; modifying the document based the type of audience for each recipient of the plurality of recipients; and providing the modified document to the plurality of recipients.

In Example 2, the subject flatter of example 1 includes: wherein modifying the document further comprises: including, in the document, different content based on the type of audience for each recipient of the plurality of recipients.

In Example 3, the subject matter of example 1 includes: wherein the modified document is received at a client device of the recipient, the client device configured to: determine the type of audience corresponding to the recipient; tailor content of the modified document based on the type of audience corresponding to the recipient; and display the tailored content.

In Example 4, the subject matter of example 1 includes: wherein modifying the document further comprises: forming a version of the shared document based on a type of output for each recipient, the type of output being based on the type of audience, wherein providing the modified document further comprises: publishing the version of the shared document to the corresponding recipient.

In Example 5, the subject matter of example 1 includes: wherein modifying the document further comprises: forming a plurality of branches of the shared document, each branch corresponding to the type of audience, each branch being viewable by a corresponding type of audience.

In Example 6, the subject matter of example 5 includes: wherein content in a first branch of the plurality of branches is being viewable only by a first recipient from a first type of audience, wherein content in a second branch of the plurality of branches is being viewable only by a second recipient from a second type of audience.

In Example 7, the subject matter of example 5 includes: wherein a first branch of the plurality of branches includes a first shared portion of the shared document, the first shared portion being viewable by the plurality of recipients and editable by the plurality of recipients, wherein a second branch of the plurality of branches includes a second shared portion of the shared document, the second shared portion being viewable only by a subset of the plurality of recipients, the subset having permission to view the second shared portion.

In Example 8, the subject matter of example 5 includes: wherein a first branch of the plurality of branches includes redacted content from a second branch of the plurality of branches.

In Example 9, the subject matter of example 1 includes: further comprising: determining a first type of audience of a first recipient of the plurality of recipients; determining that the first type of audience corresponds to a first type of document output; forming a first version of the shared document based on a first type of document output for the first recipient; publishing the first version of the shared document to the first recipient; determining a second type of audience of a second recipient of the plurality of recipients; determining that the second type of audience corresponds to a second type of document output; forming a second version of the shared document based on a second type of document output for the second recipient; and publishing the second version of the shared document to the second recipient.

In Example 10, the subject matter of example 1 includes: further comprising: detecting a portion of the modified document as confidential content; assigning an access privilege to a first type of audience; determining that a first recipient corresponds to the first type of audience; and causing a display of the confidential content in response to determining that first recipient corresponds to the first type of audience.

In Example 11, the subject matter of example 10 includes: further comprising: determining that a second recipient corresponds to a second type of audience, the second type of audience having no access privilege to the confidential content; and preventing a display of the confidential content in response to determining that the second recipient corresponds to the second type of audience.

In Example 12, the subject matter of example 11 includes: further comprising: receiving a viewing request from the second recipient to view the confidential content; receiving an authorization in response to the viewing request; and causing a display of the confidential content in response to receiving the authorization.

In Example 13, the subject matter of example 1 includes: wherein modifying the document further comprises: parsing the document and determining content that is relevant to a corresponding type of audience; forming metadata for corresponding portions of the document, the metadata indicating a type of audience corresponding to the portion of the document and key points to the document; and including the metadata in the document.

In Example 14, the subject matter of example 1 includes: wherein modifying the document further comprises: adding a first content to the document, the first content corresponding to a first type of audience; removing a second content from the document, the second content corresponding to the first type of audience; altering a third content to a fourth content in the document, the third content corresponding to the first type of audience; forming the modified document after adding the first content, removing the second content, and altering the third content; and providing the modified document to each user associated with the first type of audience.

Although an overview of the present subject matter has been described with reference to specific example embodiments, various modifications and changes may be made to these embodiments without departing from the broader scope of embodiments of the present invention. For example, various embodiments or features thereof may be mixed and matched or made optional by a person of ordinary skill in the art. Such embodiments of the present subject matter may be referred to herein, individually or collectively, by the term “invention” merely for convenience and without intending to voluntarily limit the scope of this application to any single invention or present concept if more than one is, in fact, disclosed.

The embodiments illustrated herein are believed to be described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present invention as represented by the appended claims. The specification and drawings are, accordingly, to be regarded in an illustrative rather than a restrictive sense.

What is claimed is:

1. A computer-implemented method comprising:
receiving a request to share a document to a plurality of recipients;
determining a type of audience for each recipient;
modifying the document based the type of audience for each recipient of the plurality of recipients; and
providing the modified document to the plurality of recipients.

2. The computer-implemented method of claim 1, wherein modifying the document further comprises:
including, in the document, different content based on the type of audience for each recipient of the plurality of recipients.

3. The computer-implemented method of claim 1, wherein the modified document is received at a client device of the recipient, the client device configured to:
determine the type of audience corresponding to the recipient;
tailor content of the modified document based on the type of audience corresponding to the recipient; and
display the tailored content.

4. The computer-implemented method of claim 1, wherein modifying the document further comprises:
forming a version of the shared document based on a type of output for each recipient, the type of output being based on the type of audience,
wherein providing the modified document further comprises:
publishing the version of the shared document to the corresponding recipient.

5. The computer-implemented method of claim 1, wherein modifying the document further comprises:
forming a plurality of branches of the shared document, each branch corresponding to the type of audience, each branch being viewable by a corresponding type of audience.

6. The computer-implemented method of claim 5, wherein content in a first branch of the plurality of branches is being viewable only by a first recipient from a first type of audience, wherein content in a second branch of the plurality of branches is being viewable only by a second recipient from a second type of audience.

7. The computer-implemented method of claim 5, wherein a first branch of the plurality of branches includes a first shared portion of the shared document, the first shared portion being viewable by the plurality of recipients and editable by the plurality of recipients,
wherein a second branch of the plurality of branches includes a second shared portion of the shared document, the second shared portion being viewable only by a subset of the plurality of recipients, the subset having permission to view the second shared portion.

8. The computer-implemented method of claim 5, wherein a first branch of the plurality of branches includes redacted content from a second branch of the plurality of branches.

9. The computer-implemented method of claim 1, further comprising:
determining a first type of audience of a first recipient of the plurality of recipients;
determining that the first type of audience corresponds to a first type of document output;
forming a first version of the shared document based on a first type of document output for the first recipient;
publishing the first version of the shared document to the first recipient;
determining a second type of audience of a second recipient of the plurality of recipients;
determining that the second type of audience corresponds to a second type of document output;
forming a second version of the shared document based on a second type of document output for the second recipient; and
publishing the second version of the shared document to the second recipient.

10. The computer-implemented method of claim 1, further comprising:
detecting a portion of the modified document as confidential content;
assigning an access privilege to a first type of audience;
determining that a first recipient corresponds to the first type of audience; and
causing a display of the confidential content in response to determining that the first recipient corresponds to the first type of audience.

11. The computer-implemented method of claim 10, further comprising:
determining that a second recipient corresponds to a second type of audience, the second type of audience having no access privilege to the confidential content; and
preventing a display of the confidential content in response to determining that the second recipient corresponds to the second type of audience.

12. The computer-implemented method of claim 11, further comprising:
receiving a viewing request from the second recipient to view the confidential content;
receiving an authorization in response to the viewing request; and
causing a display of the confidential content in response to receiving the authorization.

13. The computer-implemented method of claim 1, wherein modifying the document further comprises:
parsing the document and determining content that is relevant to a corresponding type of audience;
forming metadata for corresponding portions of the document, the metadata indicating a type of audience corresponding to the portion of the document and key points to the document; and
including the metadata in the document.

14. The computer-implemented method of claim 1, wherein modifying the document further comprises:
adding a first content to the document, the first content corresponding to a first type of audience;
removing a second content from the document, the second content corresponding to the first type of audience;
altering a third content to a fourth content in the document, the third content corresponding to the first type of audience;
forming the modified document after adding the first content, removing the second content, and altering the third content; and
providing the modified document to each user associated with the first type of audience.

15. A computing apparatus, the computing apparatus comprising:
a processor; and
a memory storing instructions that, when executed by processor, configure the apparatus to:
receive a request to share a document to a plurality of recipients;
determine a type of audience for each recipient;
modify the document based the type of audience for each recipient of the plurality of recipients; and
provide the modified document o the plurality of recipients.

16. The computing apparatus of claim 15, wherein modifying the document further comprises:
include, in the document, different content based on the type of audience for each recipient of the plurality of recipients.

17. The computing apparatus of claim 15, wherein the modified document is received at a client device of the recipient, the client device configured to:
determine the type of audience corresponding to the recipient;
tailor content of the modified document based on the type of audience corresponding to the recipient; and
display the tailored content

18. The computing apparatus of claim 15, wherein modifying the document further comprises:
form a version of the shared document based on a type of output for each recipient, the type of output being based on the type of audience,
wherein providing the modified document further comprises:
publish the version of the shared document to the corresponding recipient.

19. The computing apparatus of claim 15, wherein modifying the document further comprises:
forming a plurality of branches of the shared document, each branch corresponding to the type of audience, each branch being viewable by a corresponding type of audience.

20. A non-transitory computer-readable storage medium, the computer-readable storage medium including instructions that when executed by a computer, cause the computer to:
receive a request to share a document to a plurality of recipients;
determine a type of audience for each recipient;
modify the document based the type of audience for each recipient of the plurality of recipients; and
provide the modified document to the plurality of recipients.
